(19) United States
(12) Patent Application Publication
(10) Pub. No.: US 2004/0156473 A1
(43) Pub. Date: Aug. 12, 2004

(54) Radiographic apparatus

(76) Inventors: Hideki Nonaka, Tochigi (JP); Masakazu Morishita, Kanagawa (JP); Tatsuya Yamazaki, Tochigi (JP); Isao Kobayashi, Kanagawa (JP); Osamu Tsujii, Tochigi (JP); Akira Hirai, Tochigi (JP); Toshikazu Tamura, Tochigi (JP); Takamasa Ishii, Saitama (JP)

Correspondence Address: MORGAN & FINNEGAN, L.L.P., 345 PARK AVENUE, NEW YORK, NY, 10154, US

(21) Appl. No.: 10/765,386

(22) Filed: Jan. 26, 2004

(30) Foreign Application Priority Data
Jan. 27, 2003 (JP) 2003-017801

(51) Int. Cl. G01T 1/24

(52) U.S. Cl. 378/62; 378/98.8; 250/370.09

(57) ABSTRACT

An object of this invention is to appropriately execute automatic exposion control. A radiographic apparatus has a radiographic image detection section (62) which detects the radiographic image of an object and a plurality of radiation dose detection sections (631-634) which detect the dose of radiation from the object. The radiographic apparatus includes a control section (61) which decides the mode of use of the outputs from the plurality of radiation dose detection sections (631-634) on the basis of the arrangement state of the radiographic apparatus.

### FIELD OF THE INVENTION

The present invention relates to radiography of an object.

### BACKGROUND OF THE INVENTION

Methods of irradiating a subject with radiation and detecting the intensity distribution of the radiation transmitted through the subject to obtain the radiographic image of the subject are widely generally used in the fields of industrial nondestructive inspection and medical diagnosis. A detailed example of the general method of obtaining the radiographic image of a subject is a method that combines a silver halide film and a so-called “phosphor screen” (or intensifying screen) which emits fluorescence upon receiving radiation. In this method, a subject is irradiated with radiation. The radiation transmitted through the subject is converted into visible light by the phosphor screen to form a latent image on the silver halide film. After that, the silver halide film is chemically processed to obtain a visible image. A radiographic image obtained by this method is an analog radiograph which is used for diagnosis or inspection.

Computed radiography apparatuses (to be referred to as CR apparatuses hereinafter) which use an imaging plate (to be referred to as an IP hereinafter) having a stimulable phosphor layer are also becoming popular. When an IP is primarily excited by radiation irradiation and then secondarily excited by visible light such as a red laser beam, stimulable phosphorescence is generated. In the CR apparatus, the light emission is detected by a photosensor such as a photomultiplier to acquire a radiographic image. On the basis of this image data, a visible light image is output to a photographic sensitive material or CRT. The CR apparatus is a digital apparatus. However, since the read by secondary excitation, i.e., an image formation process is necessary, the CR apparatus is an indirect digital radiographic apparatus. The CR apparatus is an indirect radiographic apparatus because the radiographed image cannot immediately be displayed, as in the analog technology.

On the other hand, a technique for acquiring a digital image has recently been developed in which a photoelectric conversion device having pixels each comprising a small photoelectric conversion element and switching element arrayed in a matrix is used as a reception means. An image sensing apparatus based on this technique is a direct digital image sensing apparatus because it can immediately display acquired image data.

Advantages of the digital image sensing apparatus, which cannot be obtained in the analog photographic technique, are a filmless operation, effective utilization of acquired information by image processing, and database formation. There is also an advantage that image data can immediately be acquired and displayed. An indirect radiographic apparatus requires an image formation process such as secondary excitation. A direct radiographic apparatus however can convert a radiographic image into digital data immediately after image sensing. An indirect radiographic apparatus requires a separate read apparatus for secondary excitation. However, a direct radiographic apparatus requires no separate read apparatus.

In the conventional image sensing apparatus using a silver halide film, overexposure or underexposure readily occurs because the dynamic range for a radiation irradiation dose is narrow. To stabilize this, an automatic exposion control circuit (AEC (Automatic Exposion Control) circuit) called a phototimer is used. Radiation detection elements are arranged in front of or behind the film. The outputs from the radiation detection elements are integrated. The integrated value is compared with a predetermined set value so as to obtain a photographic density necessary for diagnosis. When the integrated value reaches the set value, the AEC circuit transmits an X-ray cutoff signal to an X-ray generation device to cut off X-ray irradiation.

A digital image sensing apparatus has a wider dynamic range than that in the conventional radiography using silver halide films. The tolerance for overexposure or underexposure is larger than in the radiography using silver halide films. Even when the arrival radiation dose is inappropriate, an image output suitable for diagnosis can be obtained by image processing such as density conversion.

However, when the arrival radiation dose becomes at low level, the effect of quantization noise or system noise of the apparatus becomes large, and the S/N ratio of the image decreases. Hence, even a digital image sensing apparatus uses an AEC circuit, like the radiography using silver halide films, in order to obtain a minimum arrival radiation dose to ensure the quality of an acquired image. A digital image sensing apparatus to which such an AEC circuit is applied is disclosed in, e.g., Japanese Patent Laid-Open No. 11-151233.

As described above, even in an image sensing apparatus which uses an image sensing section (also called a flat panel detector (FPD)) including solid-state photodetection elements, conventionally, AEC radiation detection elements separate from the FPD are arranged in front of the FPD, and an AEC circuit is operated. However, it is becoming possible to arrange the AEC radiation detection elements inside the FPD in order to meet requirements for compact and simple image sensing apparatuses, cost reduction, and advanced manufacturing techniques.

When the shape of the FPD is, e.g., rectangular (e.g., a 14″×17″ size), like a conventional film, radiographing is executed while the direction of the FPD (the direction of the FPD can be grasped as, e.g., the direction of the long side or short side or portrait or landscape) is set in accordance with the object (e.g., the body part to be radiographed or the physique) to be radiographed. If the FPD arrangement has a degree of freedom, the arrangement of the AEC radiation detection elements in the FPD is not always optimum for radiographing. In some cases, no high-quality subject image can be obtained.

More specifically, in, e.g., a stereoscopic radiography apparatus, assume that the arrangement of the AEC radiation detection elements is optimum when the FPD is set in a vertical mode (an arrangement in which the long side is set in the vertical direction; also called a portrait mode). In this case, if the FPD is set in a horizontal mode (an arrangement in which the long side is set in the horizontal direction; also called a landscape mode), the AEC radiation detection elements are arranged at positions that are not optimum. Even in an apparatus which has an FPD and AEC radiation detection elements separate from the FPD, when the FPD and AEC radiation detection elements are integrally pivoted, the above-described problem is posed.

### SUMMARY OF THE INVENTION

The present invention has been made in consideration of the above-described problem, and has as its object to, e.g., make it possible to appropriately execute automatic exposion control.

According to the present invention, there is provided a radiographic apparatus having a radiographic image detection section which detects a radiographic image of an object and a plurality of radiation dose detection sections which detect a dose of radiation from the object, comprising a control section which decides a mode of use of outputs from the plurality of radiation dose detection sections on the basis of a relative positional relationship between the object and the radiographic apparatus (e.g., the arrangement state of the radiographic apparatus).

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an equivalent circuit diagram of a photodetection pixel of a radiographic apparatus according to an embodiment of the present invention;

FIG. 2 is a schematic view of an FPD (Flat Panel Detector);

FIG. 3 is a schematic view of the radiation detection section of the FPD to which AEC (Auto Exposure Control) radiation detection pixels are applied;

FIGS. 4A and 4B are views showing the layout of AEC detection regions;

FIGS. 5A and 5B are views showing the layout of AEC detection regions;

FIG. 6 is a block diagram of the control system of the radiographic apparatus;

FIG. 7 is a flow chart showing the flow of processing of the control section; and

FIG. 8 is a block diagram of a computer.

### DETAILED DESCRIPTION OF THE PREFERRED EMBODIMENTS

A radiographic apparatus according to an embodiment of the present invention will be described next with reference to the accompanying drawings.

The structure of the radiographic apparatus according to this embodiment will be described first. A description will be done below by using an example in which a flat panel detector (FPD) is applied to a radiographic apparatus.

The schematic arrangement of the FPD will be described. The FPD is constituted by a scintillator, photodetection pixel array, and driving circuit. In the scintillator, the matrix substance of the phosphor is excited by incident radiation, and fluorescence in a visible range is obtained. Fluorescence obtained by this scintillator is generated by the matrix itself such as CaWO₄ or CdWO₄ or by a luminescent center substance such as CsI:Tl or ZnS:Ag, which is activated in the matrix.

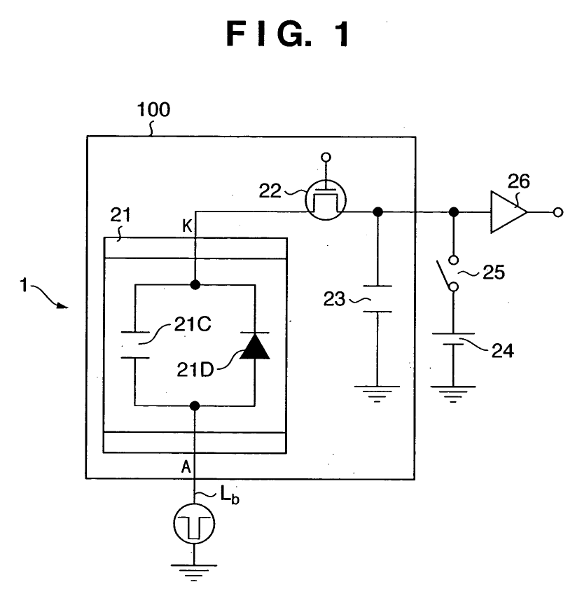

Photodetection pixels are arranged in a matrix adjacent to the scintillator. The array of photodetection pixels arranged in a matrix converts photons obtained by the scintillator into an electrical signal. FIG. 1 is an equivalent circuit diagram of one pixel of the photodetection pixel array.

In the following example, a two-dimensional amorphous silicon sensor is used. However, the detection element is not limited to this. For example, any other solid-state image sensing element may be used.

A photodetection pixel 100 has a photodetection element 21 which detects incident light and a switching TFT 22 which controls accumulation and read of charges. The photodetection pixel 100 is generally formed from amorphous silicon (a-Si) formed on a glass substrate. The photodetection element 21 has a capacitor 21C and photodiode 21D. The capacitor 21C may be either simply the parasitic capacitance of the photodiode 21D or a capacitor which is formed parallel to the photodiode 21D so as to improve the dynamic range of the photodetection pixel 100.

An anode A of the photodetection element 21 is connected to a bias line Lb serving as a common electrode. A cathode K of the photodetection element 21 is connected to the switching TFT 22 which can freely be controlled to read out charges accumulated in the capacitor 21C. In this embodiment, the switching TFT 22 is a thin-film transistor connected between the cathode K of the photodetection element 21 and an amplifier 26 for the charge read.

After the switching TFT 22 and a reset switch 25 are operated to reset the capacitor 21C, the pixel is irradiated with radiation 1. Accordingly, charges generated by the photodiode 21D in correspondence with the dose of the radiation 1 are accumulated in the capacitor 21C. When the switching TFT 22 is operated again, the signal charges accumulated in the capacitor 21C are transferred to a capacitive element 23. The charge amount accumulated by the photodiode 21D is read through the amplifier 26. When the readout signal is A/D-converted, the dose of incident radiation is detected.

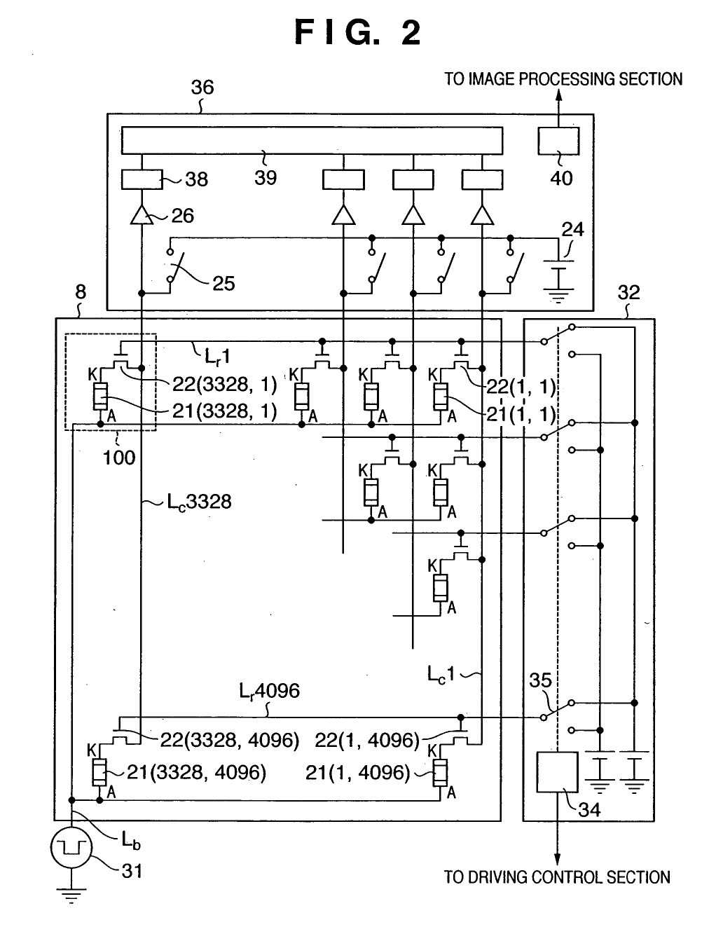

FIG. 2 is a schematic view of a radiographic apparatus having a radiographic image detection section 8 in which the photodetection pixels 100 are arrayed in a matrix.

Normally, a photodetection pixel array is constituted by about 2,000×2,000 to 4,000×4,000 pixels. The area of the array is about 200 mm×200 mm to 500 mm×500 mm. In the example shown in FIG. 2, the photodetection pixel array is constituted by 3,328 ×4,096 pixels. The area of the photodetection pixel array is 350 mm×430 mm. The size per pixel is about 105 μm×105 μm. In the radiographic image detection section 8, 3,328 pixels are arrayed in the row direction, and 4,096 pixels are arrayed in the column direction. The pixels are two-dimensionally arranged.

As described above, one pixel has the photodetection element 21 and switching TFT 22. Reference numerals 21(1,1) to 21(3328,4096) indicate the photodetection elements 21. The cathode side of the photodiode 21D is indicated by K, and the anode side is indicated by A. Reference numerals 22(1,1) to 22(3328,4096) indicate the switching TFTs 22.

The K electrodes of photodetection elements 21(m,n) of each column of the two-dimensional photodetection pixel array are connected to a corresponding one of column signal lines L_{c}1 to L_{c}3328, which are common to the respective columns, through the source and drain conductive paths of corresponding switching TFTs 22(m,n). For example, the photodetection elements 21(1,1) to 21(1,4096) of column 1 are connected to the first column signal line L_{c}1. On the other hand, the A electrodes of photodetection elements 21 of each row are connected to a bias power supply 31 through the common bias line Lb. The gate electrodes of the switching TFTs 22 of each row are connected to a corresponding one of row selection lines Lᵣ1 to Lᵣ4096. For example, the switching TFTs 22(1,1) to 22(3328,1) of row 1 are connected to the row selection line Lᵣ1.

Row selection lines Lᵣ are connected to a driving control section (not shown) through a line selector section 32. The line selector section 32 is formed from, e.g., an address decoder 34 and 4,096 switch elements 35. With this arrangement, a signal can selectively be read from an arbitrary row. The line selector section 32 can easily be constituted by using a shift register that is used for, e.g., a liquid crystal display.

Column signal lines L_{c} are connected to a signal read section 36 which is controlled by a driving control section (not shown). The signal read section 36 has a reset reference power supply 24, the reset switches 25 which reset the column signal lines L_{c} to the reference potential of the reset reference power supply 24, the preamplifiers 26 which amplify the signal potentials, sample-and-hold circuits 38, an analog multiplexer 39, and an A/D converter 40. The signals from the respective column signal lines L_{c}n are amplified by the preamplifiers 26 and held by the sample-and-hold circuits 38. The output signals are sequentially output to the A/D converter 40 through the analog multiplexer 39 and converted into digital values.

In the photoelectric conversion device of this embodiment, the 3,328×4,096 pixels are distributed to the 3,328 column signal lines L_{c}n so that signals from 3,328 pixels per row are simultaneously output. The output signals are sequentially converted into digital signals by the A/D converter 40 through the column signal lines L_{c}, preamplifiers 26(1 to 3328), the sample-and-hold sections 38 (1 to 3328), and analog multiplexer 39.

The arrangement shown in FIG. 2 is illustrated as if it were constituted by one A/D converter 40. Actually, A/D conversion can simultaneously be executed by, e.g., four to 32 systems. This arrangement is employed in order to shorten the image signal read time without increasing the analog signal band and A/D conversion rate.

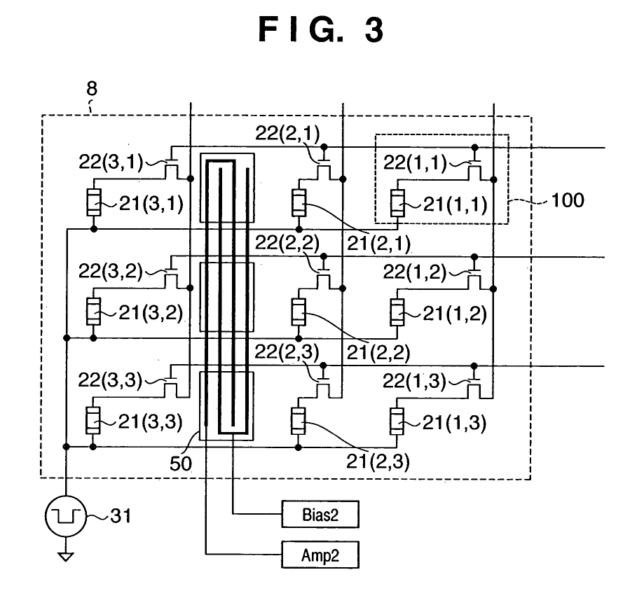

FIG. 3 is a schematic view of the radiographic image detection section 8 including AEC (Auto Exposure Control) detection elements 50. For the sake of simplicity, FIG. 3 shows only 3×3 pixels of a number of photodetection pixels 100 of the radiographic image detection section 8.

As shown in FIG. 3, the AEC detection elements 50 which are prepared to adjust the dose of radiation incident on the photodetection pixel array having the above-described structure are connected to a bias power supply (Bias2) that applies a bias and an amplifier (Amp2) that amplifies an output signal. The circuit of the AEC detection elements 50 is separated from the array of the photodetection pixels 100 and arranged in the gap between the pixels of the photodetection pixel array.

In a general photodetection pixel array, lines run in the row and column directions. In addition, to increase the opening ratio, regions except the switching TFTs 22 of the pixels are occupied by the opening portions of the photodiodes 21D as much as possible. Hence, no gap where the AEC detection elements can be arranged is present between the pixels.

In an embodiment, to form the AEC detection elements 50 on the photodetection pixel array, the opening regions of some photodetection pixels are made small. The AEC detection elements 50 are formed in the unoccupied region. In the remaining embodiments, the photodiodes 21D may completely be removed while leaving the switching TFTs 22 such that the AEC detection elements 50 can be formed in the unoccupied region. In the latter case, since an image partially lacks pixel data, pixel interpolation processing must be executed for the output digital image data.

The radiation dose detection section may be formed in a layer different from that of the pixels of the radiographic image detection section.

Generally, it is not enough that AEC detection regions corresponding to several pixels or one line are simply formed on the two-dimensional photodetection pixel array. When, e.g., radiographing a chest part of a human body, a conventional AEC device represented by a phototimer is designed to measure the dose of radiation transmitted through the pulmonary part and cut off radiation irradiation when the dose reaches a predetermined value.

Assume that an AEC detection element having a size almost corresponding to one pixel is formed on an FPD. In this case, if the formed AEC detection element is located at a position corresponding to the pulmonary part of the patient, no problem is posed. However, if the AEC detection element is not located at a position corresponding to the pulmonary part because of the difference in physique or internal structure of the patient or misalignment at the time of radiographing, the AEC detection element is arranged at, e.g., a portion where the transit dose is smaller. As a result, radiation irradiation is executed more than expected, and AEC cannot be useful.

This problem can be solved by forming the AEC detection elements 50 not in a dot-like region corresponding to one pixel but a region that is long to some extent in both the row and column directions. More specifically, for example, like a phototimer, the AEC detection elements 50 are formed in a rectangular region with a size of about 50 mm×50 mm. The AEC detection elements 50 need not be formed in the entire region. For example, when one pixel of the photodetection pixel array has a size of 105 μm×105 μm, an AEC detection region can be formed by arranging six groups of AEC detection elements 50 that are arranged in a line in correspondence with 500 pixels in the column direction, as shown in FIG. 3, every 100 pixels in the row direction.

Radiographing using an FPD having above-described AEC detection regions 51 will be described next.

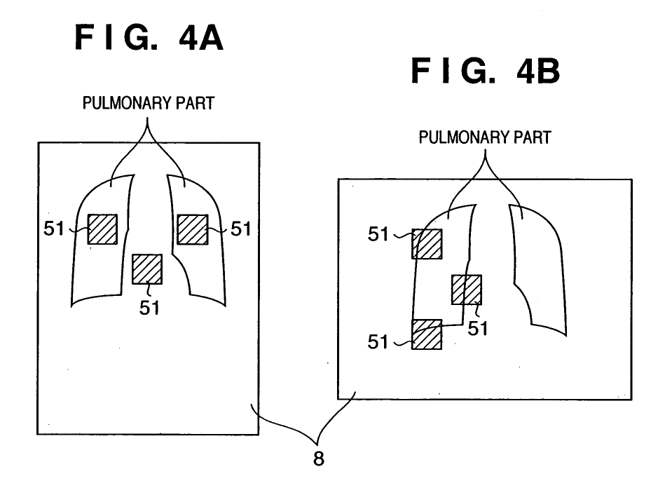

The AEC detection regions 51 formed on the FPD can be arranged to radiograph a chest part and belly part, like a phototimer. Assume that the AEC detection regions 51 are arranged, as shown in FIG. 4A, in the region of the radiographic image detection section 8 of an FPD having a 14″×17″ size. FIG. 4A shows an example in which the AEC detection regions 51 are arranged on the FPD assuming chest/belly part radiographing in a 14″×17″ size portrait mode, and radiographing is executed while setting the FPD in the vertical direction (portrait). Depending on the physique of the patient, radiographing needs to be executed while setting the FPD in the horizontal direction. In radiographing in a 14″×17″ size landscape mode, the AEC detection regions 51 in the region of the radiographic image detection section 8 of the FPD are located at positions shown in FIG. 4B. In this case, the positions of the AEC detection regions 51 are not appropriate at all for controlling the transit dose of a pulmonary part or the like. AEC can hardly be useful.

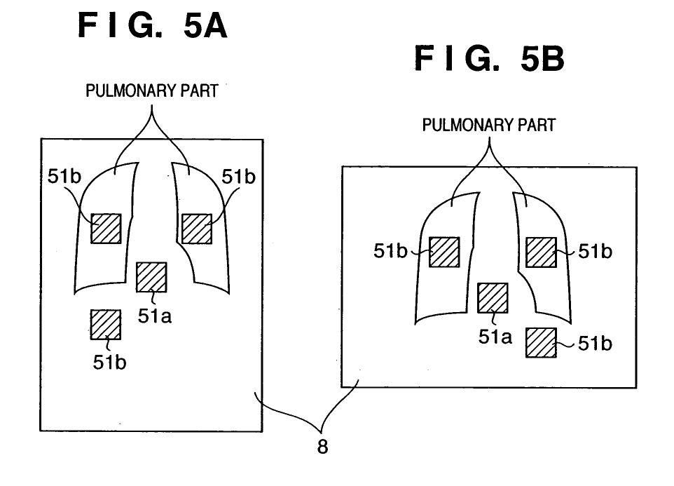

In the radiographic apparatus according to the embodiment of the present invention, as shown in FIGS. 5A and 5B, the AEC detection regions 51 (also called radiation dose detection sections) are arranged at at least four portions in the region of the radiographic image detection section 8. FIG. 5A shows the layout when the FPD having a 14″×17″ size is set in the vertical direction (portrait). FIG. 5B shows the layout when the FPD having a 14″×17″ size is set in the horizontal direction (landscape). For at least four AEC detection regions 51, a first AEC detection region 51a is formed almost at the center (the intersection between two diagonals) of the FPD. Remaining AEC detection regions 51b are arranged at positions almost equidistant from the first AEC detection region 51a. Of the plurality of AEC detection regions 5b, two arbitrary AEC detection regions 51b adjacent to each other are arranged to be symmetrical about a straight line that passes through the center of the FPD and runs parallel to the long or short side of the FPD.

In the examples shown in FIGS. 5A and 5B, assume a square whose side has a length almost corresponding to the interval between the left and right pulmonary parts (the center of the square is located almost at the center of the FPD, and one side of the square is almost parallel to one side of the radiographic image detection section 8). In this case, the AEC detection regions 51 (radiation dose detection sections) are arranged at the center and three vertices of the square. The radiation dose detection sections may be arranged at the center and four vertices of the above-described square.

With this arrangement, independently of whether the FPD having a 14″×17″ size is set in the portrait mode or landscape mode, the AEC detection regions 51 can be located at optimum positions for chest/belly part radiographing. Alternatively, an AEC detection device having the radiographic image detection section 8 (photodetection pixel array) and AEC detection sections separate from the radiographic image detection section 8 is used. The radiographic image detection section 8 and AEC detection sections are integrated such that they are integrally rotated and moved. Even in a radiographic apparatus that uses such an AEC detection device, when the AEC detection sections are arranged in the same way as described above with respect to the radiographic image detection section 8, the same effect as described above can be obtained.

In the radiographic apparatus having the above arrangement, independently of whether the FPD is set in the portrait mode or landscape mode, the AEC detection region 5la at the center and the two AEC detection regions 51b located above it (in the pulmonary parts in FIGS. 5A and 5B) are selected and used. For this purpose, the radiographic apparatus according to this embodiment includes a recognition section which recognizes the relative arrangement relationship between the subject and the radiographic apparatus (e.g., whether the device is set in the portrait mode or landscape mode), a control section which controls the radiation dose detection sections and AEC section on the basis of the recognition result from the recognition section to selectively use some of the output signals from the plurality of radiation dose detection sections for AEC, and an AEC section which controls exposure of the radiation dose detection sections on the basis of the output signals from the radiation dose detection sections selected by the control section.

The recognition section can include at least one of a detection section which detects the relative positional relationship between the subject and the radiographic apparatus and an operation section with which the positional relationship is input or set by the user. When radiographing is to be executed while making, e.g., a human or animal as a subject maintain a predetermined posture, the detection section can detect the relative positional relationship between the subject and the radiographic apparatus by detecting the posture (the direction, e.g., portrait or landscape) of the radiographic apparatus with a sensor (e.g., a photo interrupter, switch, proximity sensor, or rotary encoder). When radiographing is to be executed while setting the posture of, e.g., a human or animal as a subject in an arbitrary direction, the detection section can detect the relative positional relationship between the subject and the radiographic apparatus by detecting the posture (direction) of the human or animal through image sensing and image processing.

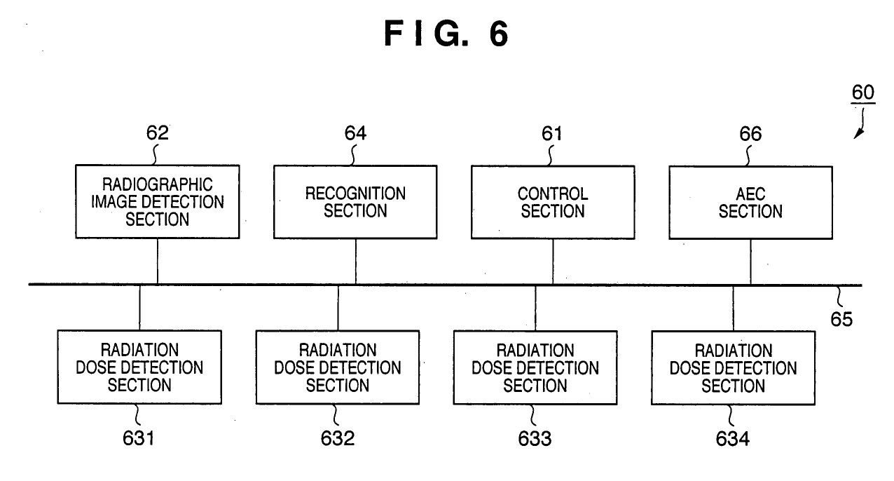

An arrangement example of the radiographic apparatus will be described with reference to FIG. 6.

Referring to FIG. 6, a radiographic apparatus 60 includes a control section 61 including a CPU and the like, a radiographic image detection section 62 similar to the radiographic image detection section 8, radiation dose detection sections 631 to 634 similar to the radiation dose detection sections 5la and 5b, a recognition section 64 which recognizes the relative positional relationship (e.g., portrait or landscape) between the subject and the radiographic apparatus, and an AEC section 66 which controls exposure of the radiographic image detection section 8 by using the radiation dose detection sections decided by the control section 61 in accordance with the recognition result from the recognition section 64. These elements are connected to be communicable through a CPU bus or a network 65. As described above, the recognition section 64 includes at least one of, e.g., a detection section (not shown) which detects the relative positional relationship between the subject and the radiographic apparatus (radiographic image detection section 62) and an operation section (not shown) with which the positional relationship is input or set by the user. The recognition section 64 can communicate with at least one of the detection section and operation section.

In the above description, the radiographic apparatus is set in one of the portrait mode and landscape mode. In accordance with the use purpose of the radiographic apparatus, the radiographic apparatus and/or the subject may assume various postures so that rotation for every arbitrary angle such as 45° in a predetermined plane may be permitted. In this case, the recognition section 64 can be designed to recognize the relative positional relationship between the radiographic apparatus and the subject in correspondence with various postures. As the layout pattern of the radiation dose detection sections 631 to 634 with respect to the radiographic image detection section 62, a pattern in which when the radiographic image detection section 62 is rotated by only a predetermined angle, e.g., 90° or less (e.g., 45° or 90°) in its radiographic image detection plane, the positions of all the radiation dose detection sections before rotation coincide with those after rotation (a rotational symmetrical layout pattern in rotation of the predetermined angle) or a pattern in which the positions of some radiation dose detection sections before rotation coincide with those after rotation is preferably used. An example of the latter pattern is shown in FIGS. 5A and 5B.

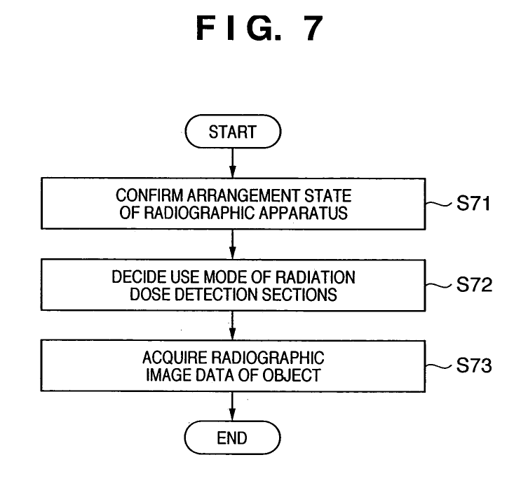

The flow of processing of the control section 61 will be described with reference to the flow chart shown in FIG. 7.

First, in step S71, the control section 61 confirms the arrangement state of the radiographic apparatus, which is recognized by the recognition section 64, as the relative positional relationship between the subject and the radiographic apparatus (radiographic image detection section 62).

In step S72, the use mode of the radiation dose detection sections 631 to 634 for AEC is decided on the basis of the arrangement state confirmed in step S71. As the use mode, for example, at least which one of the radiation dose detection sections 631 to 634 is to be used to cause the AEC section 66 to control exposure of the radiographic image detection section 62, or how to weight the output signals from the radiation dose detection sections 631 to 634 to cause the AEC section 66 to control exposure of the radiographic image detection section 62 can be decided.

In step S73, the control section 61 executes radiographing by controlling the radiographic image detection section 62, radiation dose detection sections 631 to 634, and AEC section 66 on the basis of a radiographing command from a user interface (not shown), thereby acquiring the radiographic image data of the object. In this radiographing, the AEC section 66 controls the exposure amount of the radiographic image detection section 62 by using the output signals from the radiation dose detection sections which are decided in step S72 on the basis of the arrangement state of the radiographic apparatus as the relative positional relationship between the subject and the radiographic apparatus (radiographic image detection section 62).

### (Other Embodiment)

The object of the present invention can also be achieved by supplying a storage medium which stores software program codes for implementing the functions of the apparatus or system according to the above-described embodiment to the apparatus or system and causing the computer (or a CPU or MPU) of the apparatus or system to read out and execute the program codes stored in the storage medium.

In this case, the program codes read out from the storage medium implement the functions of the embodiment by themselves, and the storage medium which stores the program codes and the program codes constitute the present invention. As the storage medium for supplying the program codes, a ROM, floppy (trademark) disk, hard disk, optical disk, magnetooptical disk, CD-ROM, CD-R, magnetic tape, nonvolatile memory card, or the like can be used.

The functions of the embodiment are implemented not only when the readout program codes are executed by the computer but also when the OS running on the computer performs part or all of actual processing on the basis of the instructions of the program codes.

The present invention also incorporates a case wherein the functions of the above-described embodiment are implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

When the present invention is applied to the program or the storage medium that stores the program, the program is constituted by, e.g., program codes corresponding to the above-described flow chart shown in FIG. 7.

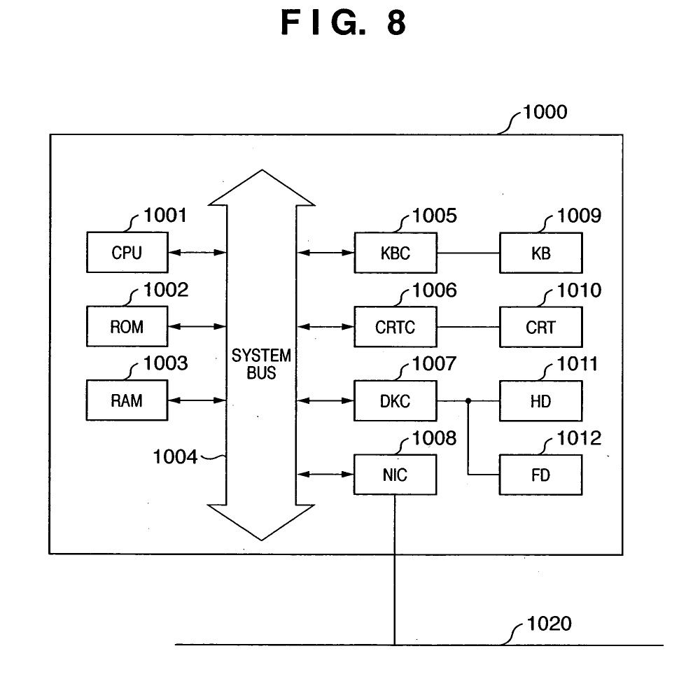

FIG. 8 is a block diagram showing the arrangement of a computer 1000. As shown in FIG. 8, the computer 1000 is constituted by connecting a CPU 1001, a ROM 1002, a RAM 1003, a keyboard controller (KBC) 1005 which executes control related to a keyboard (KB) 1009, a CRT controller (CRTC) 1006 which executes control related to a CRT display (CRT) 1010 serving as a display section, a disk controller (DKC) 1007 which executes control related to a hard disk (HD) 1011 and a flexible disk (FD) 1012, and a network interface controller (NIC) 1008 for connection to a network 1020 such that these elements can communicate with each other through a system bus 1004.

The CPU 1001 systematically controls the respective components connected to the system bus 1004 by executing software stored in the ROM 1002 or HD 1011 or software supplied from the FD 1012. More specifically, the CPU 1001 executes control to implement the operation of the above-described embodiment by reading out a processing program corresponding to a predetermined processing sequence from the ROM 1002, HD 1011, or FD 1012 and executing the program.

The RAM 1003 functions as the main memory or work area of the CPU 1001. The KBC 1005 executes control related to instruction input from the keyboard 1009 or a pointing device (not shown). The CRTC 1006 executes control related to display of the CRT 1010.

The DKC 1007 executes control related to access to the HD 1011 and FD 1012 which store boot programs, various applications, edited files, user files, network management programs, and predetermined processing programs. The NIC 1008 executes two-way data communication with the apparatus or system on the network 1020.

The present invention can be applied to a system constituted by a plurality of devices (e.g., a radiation generation device, radiographic apparatus, image processing apparatus, interface devices, and the like) or a single device in which the functions of these devices are integrated. When the present invention is applied to a system constituted by a plurality of devices, the plurality of devices build a system through, e.g., an electrical, optical, and/or mechanical communication means.

Examples of the modes of the present invention will be listed below.

[First Mode]

According to the first mode of the present invention, a radiographic apparatus having a radiographic image detection section which detects the radiographic image of an object (subject) and a plurality of radiation dose detection sections which detect the dose of radiation from the object, comprises a control section which decides a mode of use of outputs from the plurality of radiation dose detection sections on the basis of the relative positional relationship between the object and the radiographic apparatus (e.g., the arrangement state of the radiographic apparatus).

[Second Mode]

According to the second mode of the present invention, the radiation dose detection sections can be formed between the pixels of the radiographic image detection section.

[Third Mode]

According to the third mode of the present invention, the radiation dose detection sections may be formed in a layer different from a layer where the pixels of the radiographic image detection section are formed.

[Fourth Mode]

According to the fourth mode of the present invention, the radiographic image detection region of the radiographic image detection section can have a rectangle (excluding a square).

[Fifth Mode]

According to the fifth mode of the present invention, the plurality of radiation dose detection sections can be arranged such that when the radiographic image detection section is rotated by only a predetermined angle (e.g., 90° or less) in the radiographic image detection plane, the positions of all of the plurality of radiation dose detection sections before rotation coincide with those after rotation (i.e., the radiation dose detection sections are rotationally symmetrical in rotation of the predetermined angle).

[Sixth Mode]

According to the sixth mode of the present invention, the plurality of radiation dose detection sections can be arranged such that when the radiographic image detection section is rotated by only a predetermined angle (e.g., 90° or less) in the radiographic image detection plane, the positions of some of the plurality of radiation dose detection sections before rotation coincide with those after rotation.

[Seventh Mode]

According to the seventh mode of the present invention, the radiographic apparatus can further comprise a pivot mechanism which integrally pivots the radiographic image detection section and the plurality of radiation dose detection sections in the radiographic image detection plane of the radiographic image detection section.

[Eighth Mode]

According to the eighth mode of the present invention, the radiographic apparatus can further comprise a recognition section which recognizes the arrangement state.

[Ninth Mode]

According to the ninth mode of the present invention, a radiographic method applied to a radiographic apparatus having a radiographic image detection section which detects the radiographic image of an object and a plurality of radiation dose detection sections which detect the dose of radiation from the object, comprises a decision step of deciding a mode of use of outputs from the plurality of radiation dose detection sections on the basis of the relative positional relationship between the object and the radiographic apparatus (e.g., the arrangement state of the radiographic apparatus).

[10th Mode]

According to the 10th mode of the present invention, a computer program which causes a computer to execute a radiographic method applied to a radiographic apparatus having a radiographic image detection section which detects the radiographic image of an object and a plurality of radiation dose detection sections which detect the dose of radiation from the object, comprises a decision step of deciding a mode of use of outputs from the plurality of radiation dose detection sections on the basis of the relative positional relationship between the object and the radiographic apparatus (e.g., the arrangement state of the radiographic apparatus).

[11th Mode]

According to the 11th mode of the present invention, in a radiographic apparatus having a radiographic image detection section which detects the radiographic image of an object and a plurality of radiation dose detection sections which detect the dose of radiation from the object, the plurality of radiation dose detection sections are arranged such that when the radiographic image detection section is rotated by only a predetermined angle (90° or less) in the radiographic image detection plane, the positions of all of the plurality of radiation dose detection sections before rotation coincide with those after rotation (i.e., the radiation dose detection sections are rotationally symmetrical in rotation of the predetermined angle).

[12th Mode]

According to the 12th mode of the present invention, in a radiographic apparatus having a radiographic image detection section which detects the radiographic image of an object and a plurality of radiation dose detection sections which detect the dose of radiation from the object, the plurality of radiation dose detection sections can be arranged such that when the radiographic image detection section is rotated by only a predetermined angle (e.g., 90° or less) in the radiographic image detection plane, the positions of some of the plurality of radiation dose detection sections before rotation coincide with those after rotation.

As has been described above, according to the present invention, for example, automatic exposion control can appropriately be executed.

As many apparently widely different embodiments of the present invention can be made without departing from the spirit and scope thereof, it is to be understood that the invention is not limited to the specific embodiments thereof except as defined in the appended claims.

What is claimed is:

1. A radiographic apparatus having a radiographic image detection section which detects a radiographic image of an object and a plurality of radiation dose detection sections which detect a dose of radiation from the object, comprising:
a control section which decides a mode of use of outputs from the plurality of radiation dose detection sections on the basis of a relative positional relationship between the object and the radiographic apparatus.

2. The apparatus according to claim 1, wherein the control section decides the mode of use of the outputs from the plurality of radiation dose detection sections on the basis of an arrangement state of the radiographic apparatus.

3. The apparatus according to claim 1, further comprising a recognition section which recognizes the relative positional relationship between the object and the radiographic apparatus.

4. The apparatus according to claim 3, wherein the recognition section includes a sensor which detects the relative positional relationship between the object and the radiographic apparatus.

5. The apparatus according to claim 3, wherein the recognition section includes an operation section and acquires, from the operation section, information representing the relative positional relationship between the object and the radiographic apparatus.

6. The apparatus according to claim 1, wherein the plurality of radiation dose detection sections are arranged between pixels of the radiographic image detection section.

7. The apparatus according to claim 1, wherein the plurality of radiation dose detection sections are formed in a layer different from a layer where pixels of the radiographic image detection section are formed.

8. The apparatus according to claim 1, wherein a radiographic image detection region of,the radiographic image detection section has different lengths in vertical and horizontal directions.

9. The apparatus according to claim 1, wherein the plurality of radiation dose detection sections are arranged such that when the radiographic image detection section is rotated by only a predetermined angle in a radiographic image detection plane, positions of all of the plurality of radiation dose detection sections before rotation coincide with those after rotation.

10. The apparatus according to claim 1, wherein the plurality of radiation dose detection sections are arranged such that when the radiographic image detection section is rotated by only a predetermined angle in a radiographic image detection plane, positions of some of the plurality of radiation dose detection sections before rotation coincide with those after rotation.

11. The apparatus according to claim 1, further comprising a pivot mechanism which integrally pivots the radiographic image detection section and the plurality of radiation dose detection sections in a radiographic image detection plane of the radiographic image detection section.

12. The apparatus according to claim 1, further comprising an exposure control section which controls exposure of the radiographic image detection section in accordance with the mode decided by the control section.

13. A radiographic method applied to a radiographic apparatus having a radiographic image detection section which detects a radiographic image of an object and a plurality of radiation dose detection sections which detect a dose of radiation from the object, comprising:
a decision step of deciding a mode of use of outputs from the plurality of radiation dose detection sections on the basis of a relative positional relationship between the object and the radiographic apparatus.

14. The method according to claim 13, further comprising an exposure control step of controlling exposure of the radiographic image detection section in accordance with the mode decided in the decision step.

15. A computer program which causes a computer to execute a radiographic method applied to a radiographic apparatus having a radiographic image detection section which detects a radiographic image of an object and a plurality of radiation dose detection sections which detect a dose of radiation from the object, comprising:
a decision step of deciding a mode of use of outputs from the plurality of radiation dose detection sections on the basis of a relative positional relationship between the object and the radiographic apparatus.
